(19) United States
(12) Patent Application Publication
(10) Pub. No.: US 2015/0019448 A1
(43) Pub. Date: Jan. 15, 2015

(54) Crowd-Sourced Cluster Patent System And Method

(71) Applicant: INPROTOPIA CORPORATION, New York, NY (US)

(72) Inventors: Souyun Lee, New York, NY (US); Wei-yeh Lee, New York, NY (US)

(21) Appl. No.: 14/370,952

(22) PCT Filed: Jan. 7, 2013
(86) PCT No.: PCT/US13/20590

§ 371 Date: Jul. 7, 2014

Related U.S. Application Data
(60) Provisional application No. 61/584,058, filed on Jan. 6, 2012.

(51) Int. Cl. G06Q 50/18; G06Q 10/10

(52) U.S. Cl. CPC G06Q 50/184; G06Q 10/10
USPC 705/310

(57) ABSTRACT

A crowd-source cluster patent system and method are provided that magnifies the capability of a subject matter expert to manage crowd-sourced challenges in order to create derivative works from an original intangible asset. The System brings together crowds of inventors, and crowds of patent writers and crowds of patent attorneys in order to rapidly create high value, cluster patents around a seed patent and file them.

### PRIORITY CLAIM/RELATED APPLICATION

This application claims the benefit under 35 USC 119(e) and 120 to U.S. Provisional Patent Application Ser. No. 61/584,058 filed on Jan. 6, 2012 and entitled “Crowd-Sourced Cluster Patent System and Method”, the entirety of which is incorporated herein by reference.

### APPENDICES

Appendix A (an 85 page presentation) is a presentation describing a Crowd-Sourced Cluster Patent System and Method.

Appendix B (a 45 page document) contains wireframes of the various user interface screens of an example of the Crowd-Sourced Cluster Patent System.

The entirety of Appendices A and B form part of the specification and are incorporated herein by reference.

### FIELD

The disclosure relates generally to a system and method for generating innovations based on crowd sourcing.

### BACKGROUND

Now that the America Invents Act has been enacted into law, individuals, LLCs, organizations, Corporations etc. need to be able to be the first to file a patent. Even corporations with world class IP harvesting processes outsource their patent filing process. After filing their first initial patent in a space, there are always extensions and holes in the patent. Cluster Patenting fills in the holes and finds the extensions. This process takes corporations several years to perform this task.

In a Corporate setting, there are multiple people in multiple organizations and external resources that need to collaborate and synchronize in order to come up with a Cluster Patent which causes the Cluster Patent Process to take years to come up with a protective portfolio of patents. The inefficiencies of communications between disparate groups causes tremendous increases in the time required to create cluster patents.

In Corporate settings, cluster patenting is subject to corporate politics where each organization has its own interests and has multiple approval processes to navigate.

Thus, it is desirable to provide a cluster patent system and method that overcomes the above limitations and it is to this end that the disclosure is directed.

### BRIEF DESCRIPTION OF THE DRAWINGS

FIGS. 1A, 1B and 1C illustrate an implementation of the crowd-sourced cluster patent system and its components;

FIG. 2 illustrates a method for crowd-sourced cluster patenting that may use the system in FIGS. 1A and 1B;

FIG. 3 illustrates an example of a patent tree management component of the crowd-sourced cluster patent system;

FIG. 4 illustrates an example of a instant patent filing component of the crowd-sourced cluster patent system;

FIG. 5 illustrates an example of a data schema for a scoring component of the crowd-sourced cluster patent system;

FIG. 6 illustrate an example of a set of metrics that are part of the crowd-sourced cluster patent system; and

FIG. 7 illustrate an example of an inventor profile system component of the crowd-sourced cluster patent system.

### DETAILED DESCRIPTION OF ONE OR MORE EMBODIMENTS

The disclosure is particularly applicable to the crowd-sourced cluster patent system and method that is described below and it is in this context that the disclosure will be described. It will be appreciated, however, that the system and method has greater utility since the system and/or method can be implemented in other ways that those disclosed below that are within the scope of the disclosure. Furthermore, the platform described below may be used with the various intangible assets described below and is not limited to specific patent implementation described below.

The crowd-sourced cluster patent system magnifies the capability of a subject matter expert to manage crowd-sourced challenges in order to create derivative works from an original intangible asset. The System brings together crowds of inventors, and crowds of patent writers and crowds of patent attorneys in order to rapidly create high value, Cluster Patents around a seed patent and file them.

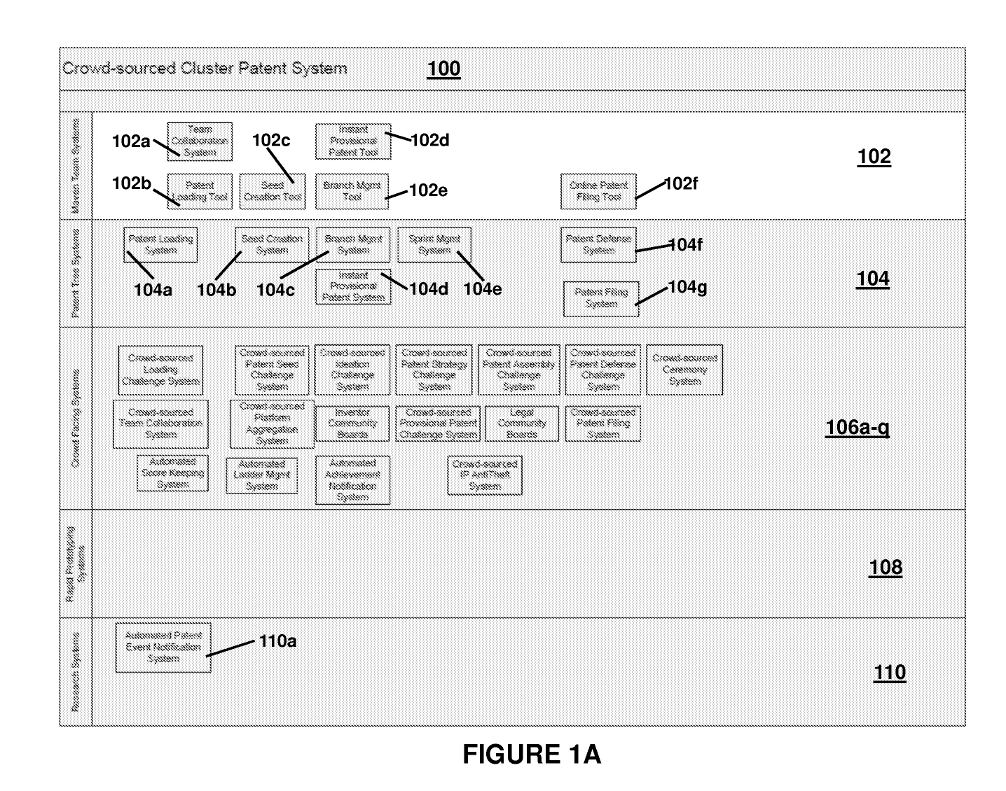

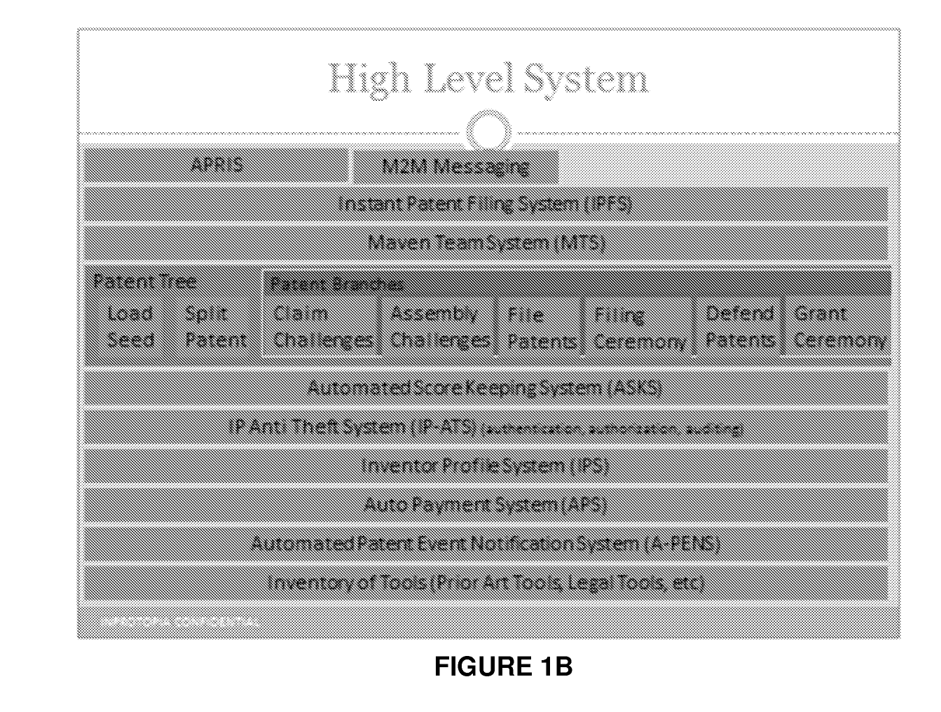

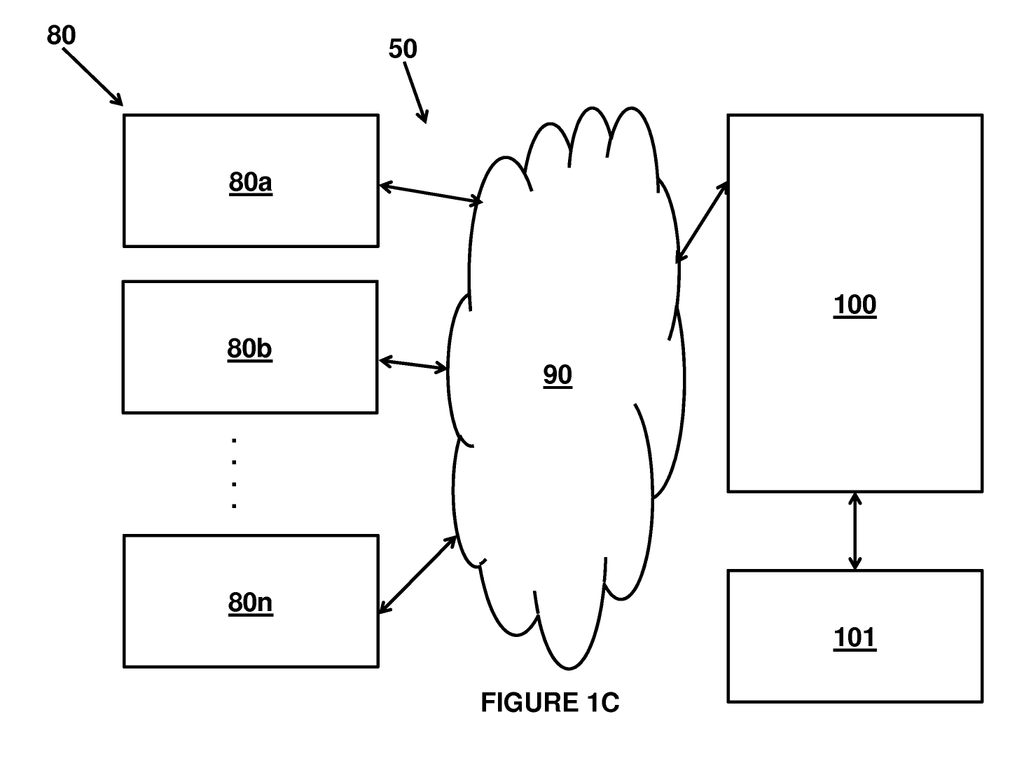

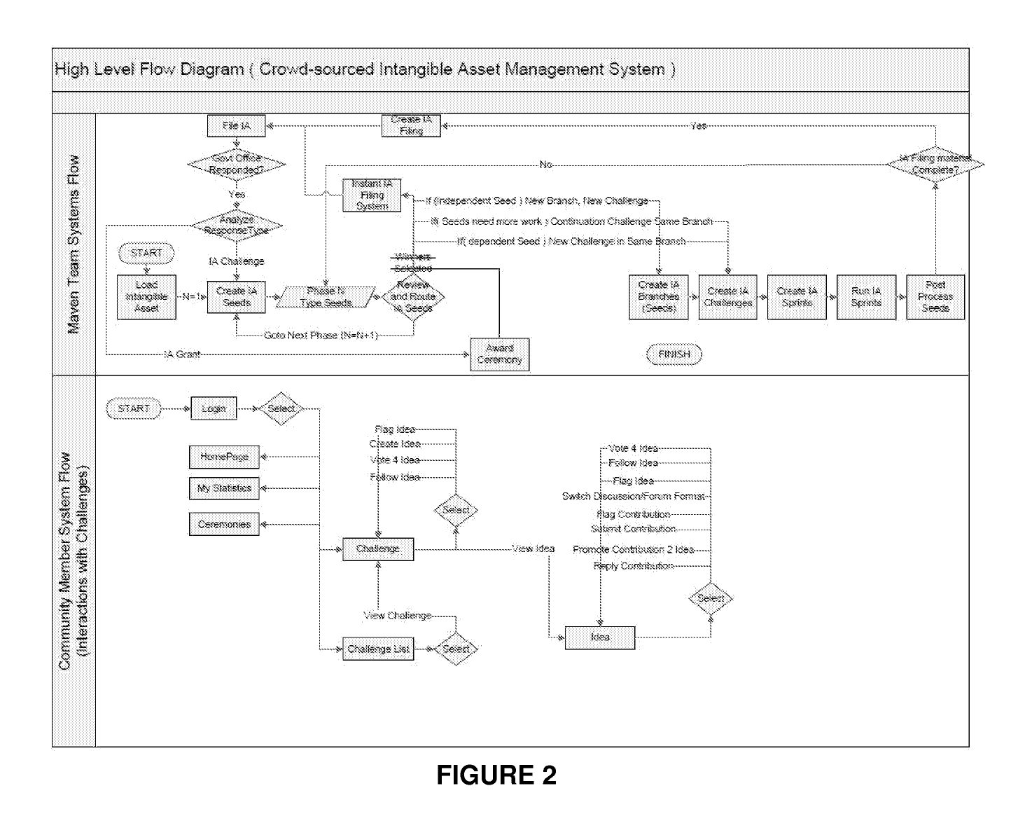

FIGS. 1A, 1B and 1C illustrate an implementation of the crowd-sourced cluster patent system 50 and its components. The system may also be known as a crowd-sourced derivative asset system. Across all components of the Crowd-sourced Derivative Asset Creation System, every crowd member using the system will be identified by a unique user id. Those skilled in the art will understand that this unique user id could be manifest in the form of a cookie, a unique id in a database, etc. The unique user ids can be allocated to a specific software tool; a specific user or a specific execution of a software tool.

As shown in FIG. 1C, the crowd-sourced cluster patent system 50 may include one or more computing devices 80, such as 80a, 80b, . . . , 80n in FIG. 1C, that may interact with a crowd-sourced cluster backend 100 over a link 90 as described below in more detail.

Each of the one or more computing devices 80 may be a computing device with one or more processors, a memory, a persistent storage device and circuitry for connectivity (wired or wireless) so that the computing device can connect to and exchange data with the crowd-sourced cluster backend 100. For example, the computing device may store and execute a browser application to connect to and exchange data with the crowd-sourced cluster backend 100 in the form of user interfaces, such as web pages. For example, each computing device may be a smartphone device, such as an Apple iPhone, RIM Blackberry and the like, a personal computer system, a laptop computer, a tablet computer, a terminal device or any other link connected device.

The link 90 may be a wired link or wireless link that allows digital data exchange between each computing device and the crowd-sourced cluster backend 100. The link may allow each computing device to establish a separate, but concurrent communications session with the crowd-sourced cluster backend 100. The link 90 may be an Ethernet connection, the Internet, a computer network, a digital wireless data network, etc.

The crowd-sourced cluster backend 100 is shown in more detail in FIG. 1A. The crowd-sourced cluster backend 100 may further include a store 101 that stores the various data associated with the crowd-sourced cluster backend 100 including user data, patent data and the like. The crowd-sourced cluster backend 100 may be implemented as a piece of hardware that programmed to operate as described below, but may also be implemented as a plurality of lines of computer code that may be stored on a computer system and executed by one or more processor(s) of the computer system. The computer system may be one or more server computers, a computer system, one or more cloud based computing resources and the like wherein each computer system has one or more processors, a memory and other known components. The crowd-sourced cluster backend 100 may also be implemented on a computer readable medium, such as a compact disk, DVD, optical drive, etc. in which the plurality of lines of computer code or instructions are stored in the computer readable medium. Furthermore, the crowd-sourced cluster backend 100 may also be implemented as one or more downloadable files. In the client/server type architecture shown in FIG. 1C, each computing device 80 may have a browser application or other application that allows the user of the computing device 80 to interact with the crowd-sourced cluster backend 100 as described below in more detail.

As shown in FIG. 1A, the crowd-sourced cluster patent backend 100 may include, for example, a maven team system 102, a patent tree system 104, a crowd facing system 106, a rapid prototyping system 108 and a research system 110. Each of these systems (and the systems that are within each of the systems) in FIG. 1A may be implemented as a plurality of lines of computer code that are executed on the computer system that hosts the backend 100. Each of the systems/components of the crowd-sourced cluster patent backend 100 may be geographically distributed (such as when cloud computing resources are used), but may also all be located in one location. The maven system 102 may be used by one or more experts in the area of the intangible asset and allows the experts to manage the crowd. For example, for a patent crowd sourced system, each maven may be an individual with knowledge about a patent.

The maven team system 102 may further include a team collaboration component 102a that promotes collaboration among the mavens of the system, a patent loading tool 102b that is described below in more detail, a seed creation tool 102c described below in more detail, an instant provisional patent tool 102d described below in more detail, a branch management tool 102e described below in more detail and an online patent filing tool 102f described below in more detail. Each of these tools allow the one or more mavens to manage the members of the crowd during the challenges, the seed creation and the like as described below, in the figures and in the Appendices.

The patent tree system 104 may further include a patent loading system 104a described below in more detail that interacts with the patent loading tool 102a, a seed creation system 104b described below in more detail that interacts with the seed creation tool 102c, a branch management system 104c described below in more detail that interacts with the branch management tool 102e, an instant provisional patent system 104d described below in more detail that interacts with the branch management tool 102e and a sprint management system 104e described in more detail below. The patent tree system 104 may further include a patent defense system 104f described in more detail below and a patent filing system 104g described in more detail below that interacts with the online patent filing tool 102f.

The crowd facing system 106 may further include a crowd sourced loading challenge system 106a described below, a crowd sourced team collaboration system 106b as described below in more detail, an automated score keeping system 106c as described below in more detail, a crowd sourced patent seed challenge system 106d, a crowd sourced platform aggregation system 106e, an automated ladder management system 106f, a crowd sourced ideation challenge system 106g, an inventor community board 106h, an automated achievement notification system 106i, a crowd sourced patent strategy challenge system 106j, a crowd sourced provisional patent challenge system 106k, a crowd sourced IP antitheft system 106l, a crowd sourced patent assembly challenge system 106m, a legal community board 106n, a crowd sourced patent defense challenge system 106o, a crowd sourced patent filing system 106p and/or a crowd sourced award ceremony system 106q.

The award ceremony system 106q may be implemented using a number of user interface screens. For an award ceremony, an administrative user may make a Prize Ladder using the automated ladder management system 106f and associates metrics with each Ladder Rung. The generated Prize Ladder may be associated with one or more challenges, such that whenever the Challenges are viewed, the Prize Ladder is visible as shown in the user interface screens. Upon the conclusion of a challenge, the Domain Admin user can ‘award’ prizes using an AwardTool that may automatically display a list of users for the set of challenges associated with the Prize Ladder. The list of users may be sorted based on the metrics assigned at the beginning and the Admin User can award prizes by selecting users for the prizes that were defined at the beginning. When prizes are awarded, this information may be passed to the award ceremony system 106q which publishes the award to the public site and triggers the fulfillment of said awards. In addition to any IP assignment disclosure that was assented to join the site and an optional IP assignment disclosure that may have been required for the user to enter a specific challenge, the platform may generate and send the IP assignment forms for the winners to sign for the purposes of U.S. patent office filings.

The research system 110 may further include an automated patent event notification system 110a that is described in more detail below and also described in co-pending patent application Ser. No. 13/______ filed on ______ and titled “Automated Patent Event Notification System”, the entirety of which is incorporated herein by reference. FIG. 1B shows further details of the crowd sourced platform including some of the same modules as shown in FIG. 1A, such as the maven system, as well as other modules and system that are described in more detail in below.

Crowd-Sourced Collaboration Challenge Management System

The heart of the system is a Crowd-sourced Collaboration Challenge Management System. Unlike existing Competition based systems where individuals are competing against each other in order to claim a prize, the Collaboration Challenge seeks to foster collaboration where the entire group of people who collaborate and build upon each other's ideas to come up with a winning product turns out to be the winner. In order to enable this “additive collaboration” where the sum of the collaboration creates a product more valuable than the individual parts, the system may use the threaded web forum and the wiki. Individually, these are distinct collaborative systems that are widely used and are successful in fostering collaboration of crowds. Forums are very successful to enable crowds to quickly identify a discussion's context and post responses without having to spend a significant amount of time doing research. Wiki's are very successful enabling crowds to have a crowd-mediated product that can be driven to completion. Both systems enable creation of ideas in a unstructured format.

The innovation that the Crowd-sourced Collaboration Challenge System consist of
1. a textual set of instructions typically given by an expert team.
2. A “seed” object that will provide all of the necessary background information and context for the challenge.
3. a structured concept of a “seed” data package which consists of all the components necessary to create an Intangible Asset, including all of the supporting materials. For example, in the case of a patent claim, a “seed” could consist of the claim, summary claim paragraphs, detailed claim paragraphs, background paragraphs, references, diagrams, etc.
4. A user moderated, curated and controlled MicroWiki that represents a crowd-sourced community user's response to the Challenge posted. Dynamically mirroring the structure of the seed of the Challenge, the MicroWiki may be composed of:
   a. Dynamic moderated Wiki
   b. Dynamic moderated Forum
both of which can accept the threaded posting of any of the components of a defined input seed as a forum posting.
   c. Tools that enable the MicroWiki Moderators and Mavens to curate the MicroWiki. Some of these tools may include:
      1. A Tool that may include the forum contributions into the moderated Wiki portion of the MicroWiki. By including Forum contributions, the author of the contribution becomes a co-moderator in the MicroWiki as well. The co-moderator list for the MicroWiki, then becomes the “potential inventor list” if the MicroWiki is selected by the Maven to become part of the intangible asset. This tool may enable the community to self-select their contributors and automatically provide an audit trail for whose contributions have been included.
      2. A tool that may enable a Maven, and Moderators to quickly view who provide which contributions to the Moderated Wiki so they can easily identify who contributed what to a MicroWiki. For example, if a patent attorney Maven needs to quickly decide who should be listed as inventor for a particular Idea MicroWiki, they would use this tool to look at all of the contributions (text, edits, diagrams, etc) of each user so they can determine whether or not a user contributed to the actual claim or not.
5. A user moderated and driven input mechanism that allows a community member to “promote” a particular forum posting to a wild. This would have the effect of converting one or more forum postings into a single dynamically restructured wild that is structured using the same seed type as the forum posting.
6. A dynamically restructured wiki that can accept the posting of any of the components of a defined input seed as a wild submission.

For example, if the “seed” were composed of
1. a patent claim
2. background paragraphs
3. summary claim paragraphs
4. detailed claim paragraphs
5. diagrams
6. references
7. etc.

Then the dynamic forum would be created with the “seed” and configure itself to be able to accept postings of any of the components of the seed to create a “forum posting”. This ability to rapidly post enables brainstorming in context of the posts around it. At some point, a community member could for example press a “promote” button that is tied to a specific forum post and this would create a dynamic wiki out of all of the components of that original post and the parent posts which are based on the same seed type. This would enable the community member to become moderator for the dynamic wiki around that idea.

There could be specific types of Challenges that are focused on different types of seeds. For example, we could have different seed types for Claim Ideation, Patent Assembly, Patent Defense, etc. As another example, one could make seeds to crowd-source operational tasks for example, Exceptions, Quality Assurance, etc.

From a community member's perspective, they would register for an account. Once they are approved for an account, they have access to their member homepage an example of which is shown on page 4 of Appendix B. On the member homepage, they would be able to view their event log which tells the member what relevant events are happening right now. The member would also have the ability to view his/her personal inventor statistics based on their activity across the platform. The member would have the ability to join challenges where participation points and inventor points can be earned. For members who have earned recognized achievements, there would be regularly scheduled ceremonies to honor the achievements. Community members would be welcome to join in the recognition and again obtain participation points for attendance and wishing the award winners well.

The community member would also have the choice to view available challenges (an example of the user interface is shown in pages 12-13 of Appendix B) which are made visible to them. Community members have customization selection settings that they control; however, the final set of challenges visible to the community member are also filtered by personalization selection settings defined by the platform owner, and personalization selection settings defined by the sponsor of the challenge. Examples of customization settings that a member could control include matching or excluding challenges based on their profile and personal choices. For example, this could include attributes indicating a level of personal interests, topic attributes, keyword attributes, category attributes, social network based recommendation engines, attribute based recommendation engine suggestions, etc.

Examples of platform owner settings can include or exclude a member from being able to see a particular challenge based on the member's profile attributes, the member's device attributes, the time of day, the challenge's profile attributes. This enables the presentation of a personalized list of challenges for a specific member. For example, some member's profile can be gathered explicitly or deduced implicitly. Example attributes that the system could gather could be:
1. number of active challenges that they are participating in
2. area of expertise
3. industry
4. employer
5. home address
6. birthday
7. work address
8. work hours
9. level of education
10. studentStatus
11. boundByProprietaryInformationAgreement
12. major area of study
13. minor area of study
14. personal hobbies
15. areas of interest

Examples of Challenge specific attributes could include
1. number of participants
2. number of active participants
3. posts per last hour
4. posts per hour average
5. ideas per hour
6. ideas per hour average

Based on the ruleset, a specific challenge may or may not be visible to the community member. For example, a platform requirement might be: if the member
1. has an employment agreement that prevents them from assigning IP and
2. is connecting using a corporate device
3. is working on company time
then don't let them see a specific set of challenges.

The system is able to identify that a user has an employment agreement and when the user tries to go into challenges sponsored by companies other than their employer, they will get a popup to get them to verify that they are not using the site on company time and are not using company devices to access the site. If the user chooses to assert that they are not using company time or devices, then we will log the response. This popup will happen each time the member tries to access challenges during likely working hours or from a company device. When the user is not working on company time, the popup will not show up. This can be done by asking the member for their employer, whether or not they have signed a proprietary information agreement with their employer, and what hours they work daily. Based on these factors, one skilled in software development can develop a system that fulfills the requirements above.

A sponsor will set a sponsor profile of attributes that will automatically apply to any intangible asset (IA) Tree that the sponsor starts. At each level (IA Tree, IA Branch, IA Sprint, IA Challenge) the attributes can be overridden by the sponsor. These attributes are used by member rulesets to identify challenges that may match member desires.

Sample Sponsor Attributes
industry={industryName|null}
technology={techName|null}

A sponsor's ruleset to define a community may include or exclude specific members from seeing their IA Tree related Challenges based on the member's attributes.

Sample Member Attributes
1. isCurrentlyStudent={true|false}
2. isCurrentlyEmployed={true|false}
3. employer={employerName|null}
   1. ex: employer=IBM
4. industry={industryName|null}
   1. ex. Industry=eCommerce
5. communities={communityName|null}
   1. ex: communities={student, columbia, . . . }

rulesets can be used to define membership in communities.
Student={isCurrentlyStudent=true}
partTimeStudent={employer!=null and isCurrentlyStudent=true}
fullTimeStudent={employer=null and isCurrentlyStudent=true}

In order to implement the view of Challenges visible to a specific community member, there are a number of components that are required. First, each community member needs to have a profile with a rich set of attributes that enable platform owners and sponsors to write rules that would match the user attributes. Second, each Challenge must have a rich profile of attributes that describe the Challenge in such a way that members would be able to write rules that would match the Challenge attributes. Platform owners, and sponsors have an easy to use interface that allows them to easily build up rules and rulesets to automatically filter and select the community members for their challenges. Community members also have an easy to use interface that allows them to easily build up rules and rulesets to automatically filter and select Challenges that are interesting to them. The sponsor rulesets are executed first to choose the subset of the community members who would be allowed to see the sponsor's challenge. If a specific ruleset is not defined for a particular challenge, then the ruleset for the IA Sprint will be utilized. If there is no IA Sprint ruleset, then the system will use the IA Branch to select a ruleset. If the IA Branch does not have a ruleset, then the system will use the IA Tree ruleset as a default. An IA Tree must have a default ruleset which could be automatically seeded by the ruleset preferences of the company.

For Claim Ideation, the seed would be composed of the component parts of a Utility, Design or Plant patent. The Collaboration Challenge System could be hard coded, configured or dynamically configured to handle the different components of each of the types of patent.

For a Patent Strategy Challenge, the Patent Strategy Seed for example could be composed of
a. Strategy Domain: unique name for a strategy domain. This could be auto-filled or presented as a dropdown based on a library of existing Strategy Domains or a Legal Community member could create a new Strategy Domain that doesn't exist by entering in a textual name.
b. Domain Tactic: a Specific tactic within that domain
c. Tactic Adaptation: a specific set of instructions that describes how to adapt the tactic to the patent in question.
d. Rationale: a textual description of why this tactic is the best choice amongst the known universe of tactics within the domain.

For a Patent Assembly Challenge, the Patent Assembly Challenge seed could for example be composed of
a. Original Seed: A reference to the original Seed resulted from the Ideation Phase
b. Legal Seed: This Seed has the same anatomical structure of the original seed. The only difference is that every item has been reviewed and updated to legally supportable.
c. Patent Components: These are the parts of a patent that are properties of the patent overall and not specifically related to a single claim. Examples would include the abstract, inventor list, etc.

For a Patent Defense Challenge, the Patent Defense Seed could for example be composed of components of any of the following types of patent office action letters. For example in the USA, the USPTO might respond with

a. Examiner's Amendment Letter

b. Priority Action Letter

c. Office Action Letter

d. Suspension Letter

Depending on the type of letter or letters sent, the system would automatically scan, load and break the Letter contents into its components. From there the Maven Team would use the Seed Creation Tool to assemble the Seeds based on the sections of the Letter. These Seeds would then be used to initialize Challenges within the Branch and automatically invite the named inventors, strategy participants, and assembly participants to join the defense challenge. The end result of the defense Challenge will be to have a list of recommended courses of action.

Crowd-Sourced Exception Handling and Quality Assurance

In order to handle Exceptions and Quality across all components of the system we can allocate Exception Handling Challenges and Quality Assurance Challenges for each of the components.

While one of the loading interfaces loads an intangible asset into the computer, there are exceptions that often happen. In order to handle exceptions, they must be categorized typically by Exception classes and then the exceptions are handled by people. Normally this is a manual process that requires an in-house staff to monitor exception logs and then manually fix the problem. In this system, the exceptions are routed to a Crowd-sourced IALS exception interface where exceptions are handled, corrected and the Intangible Asset components that triggered the exception placed back into the system for processing. Metrics regarding exception counts, rates are associated with the appropriate tools or user ids that caused the exceptions.

In order to handle crowd-sourcing of quality assurance of the Intangible Assets loaded, there will be a quality assurance crowd-sourced interface that enables the crowd to select a random sample of Intangible Asset components and validate them for their quality. Once the QA methodology has been defined by a trusted QA group, then the QA methodology can be posted and the general crowd can now participate in performing Quality Assurance on the Intangible Asset Components. When a Crowd member or trusted QA group member uses the IALS QA user interface to perform Quality Assurance checks on an Intangible Asset, they will assign the Intangible Asset Component a quality metric. This metric is then automatically associated to the Component and to the creator of the component. In this IALS QA user interface, QA metrics are gathered for the efficiency of the Crowd members' unique user id performing the QA role. Trusted QA group members will use a Trusted QA Interface to perform statistical sampling of the work done by Crowd members performing the QA role and will adjust the metrics associated with the particular Crowd Member's QA performance accordingly.

4. Intangible Asset Loading System

The Intangible Asset Loading System (IALS) enables an intangible asset to be loaded into a computer's memory and stored into persistent storage (like a file or a database) as a network of atomic components. Examples of Intangible Assets (IAs) include Patents (Utility Patents, Design Patents, Plant Patents, Reissue Patents, Defensive Publications (DEF) and Statutory Invention Registration (SIR)); Copyright-able materials such as books, music, research and other forms of creative expression; Trademark or Service-mark and/or a piece of prior art. A defensive publication is a published article, white paper and/or description that is publicly available so that a third party cannot try to patent the ideas contained in the defensive publication and/or cannot assert that a claim covers the ideas contained in the defensive publication. For example, certain ideas generated by the crowd using the platform may have a patent property generated while other ideas that are not patented may have a defensive publication generated by the platform. The prior art may be a publication that may be used to invalidate another patent filing. The platform allows each type of intangible asset to be generated using crowd sourcing.

Each atomic component may be a paragraph, a diagram, a reference, a molecule definition, and/or other material described as a UNIT in RedBoook.XML or a similar unit in another format. In many cases, the system and method may define the atomic components for a particular type of intangible asset on an adhoc basis. For example, for a patent, the atomic components may include a paragraph or text, a diagram and a reference to another piece of content. Each of the atomic components are assigned a unique identification numbers so they can be easily identified, referenced, traced, and reused in future derivative works. There can be multiple interfaces to the IALS. One loading interface could consist of a tool that reads a document type definition of the intangible asset and then loads the intangible asset into memory as atomic components. Each atomic component is assigned a unique ID and a relationship between each of the atomic components is maintained. Each loading interface tool is assigned a unique user id. Another loading interface could be a crowd-sourced loading interface where the crowd is provided a copy of the intangible asset in question and they can use whatever means they can to break down the intangible asset into its constituent parts. The user interface enables the crowd member to associate the newly entered component of the Intangible Asset with another component of the Intangible Asset. Each component of the Intangible Asset is given a unique ID. Each member of the crowd using the crowd-sourced loading interface is assigned a unique user id. The crowd-sourced interface is particularly helpful when automated tools are not available. Metrics regarding volume, quality, and other user specific metrics are associated with the user's unique id. The atomic components and their relationships to each other are stored in a database.

Crowd-sourced Patent Loading System is an example of an Intangible Asset Loading System.
In this case, the Intangible Asset is a patent.
   1. Patent Loading Tool (102b) is a software tool that enables an individual to automatically load the patent into its atomic components. For example, one skilled in the art would be able to write a tool using java, xjc and jaxb to load a xml patent into its atomic components based on the USPTO redbook document type definitions.
   2. Crowd-sourced Patent Loading User Interface (106a) that enables a member of the crowd to enter in a paragraph of a patent into the User Interface whereupon it will be given a unique id, categorized as a particular type of patent component and associated with a designated patent.

5. Intangible Asset Seed Creation System (104b)

The Intangible Asset Seed Creation System (IASCS) is a system that takes atomic components of an Intangible Asset and groups the atomic components into seeds based on rules for seed creation. There can be two general interfaces to the IASCS—an automated tool (102c) that reads the rule file and groups the Intangible Asset Components which were loaded by a IALS into seeds or a Crowd-sourced User Interface (106d) that allows people to use a UI to manually group the Intangible Asset Components into seeds so they can be loaded into a crowd-sourced branch management system for processing. Given an Intangible Asset key that defines the root Intangible Asset component, both systems read the atomic data

Patent Seed Creation System (104b)

An example of an Intangible Asset Seed Creation System would be a Patent Seed Creation System. In this specific implementation, the Patent Seed Creation System would have two input systems whose exceptions and quality could be monitored by the overarching Exception Challenges and QA Challenges.
Patent Seed Creation Tool is a software tool that enables the user select a Seed configuration file and a Seed generation ruleset; connect to the in-memory Intangible Asset Components or the persisted Intangible Asset Components; create an empty Seed object; and populate the empty Seed Object with references or copies of the Intangible Asset components that match the Seed generation rules.
Crowd-sourced Patent Seed Creation User Interface is a Crowd-sourced UI that enables crowd members to manually navigate through the Patent Components and create a patent seed out of these components. Standard Seed validation rulesets can be applied to ensure the resulting seed does not violate any obvious rules.

Crowd-Sourced Challenge Management System

The Crowd-sourced Challenge Management System is comprised of the following components:
1. Administrator User Interface—The Administrator Interface enables a user with administrative rights to fix problems for the Maven Team or for the Crowd. Basic UI functions will include 1. fetching logs so the administrator can identify issues. 2. restarting components of the overall system. 3. overriding default values and settings in the system to obtain the desired effect, with the appropriate audit logging in place.
In the Enterprise Model, each organization that uses this platform has an Administrative User Interface where they can manage the entire life-cycle of Intangible Asset Trees being built for their organization. The basic functions they will have include
1. Intangible Asset Tree Monitoring tools
2. Intangible Asset Tree Funding tools
3. Intangible Asset Purchasing interfaces
   Maven Team System (102)—the Maven Team System is a set of user interfaces that enables an individual expert or a team of experts to guide and collaborate with the crowd in order to create Intangible Assets. The Maven Team tools will include:

General Maven Team System Functions Across all Intangible Asset Tree Phases:
1. Intangible Asset Seed Reviewing and Routing
   Routing IA Seed to continuation Challenge with specific guidance
   Routing one or more IA Seeds to Instant Provisional IA Filing
   Routing one or more IA Seeds to create a new IA Branch
   Selection of IA Seed as a new base claim, then execute Both 2 and 3.
      Selection of IA Seed as complete.
2. Collection of selected Seeds to act upon.
3. Sprint Management
   Creation of a Sprint (a time bound race to run a challenge within)
   Creation of Challenges given a Seed: this tool simply enables the Maven Team to put a textual comment to set a goal for the community building ideas around Seed
      Lining up a Challenge for a Sprint (could be ordered, random, etc)
      Setting up Sprint Staggering (staggering would give the Maven Team time to process the results of one Challenge before needing to process the results of the next Challenge. The default value could be automatically populated based on the Maven Team's throughput metrics.
      Launching of Sprints
      Launching one off Challenges
      Ending or extending Sprints
      Ending or extending one off Challenges
4. Creation of Challenges using a Contribution node in the forum.
5. Instant Provisional Intangible Asset Filing given a Seed or set of Seeds
   Example: Instant Provisional Patent Filing System would be one implementation. See below.
6. Creation of Intangible Asset Branches given a Seed
   With an optional routing first to the Instant Intangible Asset Filing System prior to creation of the first Challenge. There are 2 options:
      Default setting is to route it here prior. Maven Team member would have to consciously unselect it.
      Default setting to route seed directly to a Challenge initialization, so the Maven Team would have to consciously choose to route seed to Instant Intangible Asset Filing System unset Example: Instant Provisional Patent Filing.
7. IA Ceremony Tools
   Automated Award Announcements: once the maven team selects a set of winning IA results from a challenge, automated award announcements are sent out to all participants who contributed to the winning results.
   Automated Monetary Awards: once the maven team selects a set of winning IA results from a Challenge, the monetary awards are automatically paid out based on the list of participants who contributed to the final result.

IA BootStrapping Phase Tools
1. Intangible Asset Loading
2. Intangible Asset Seed Creation and Editing

IA Ideation Phase Tools
1. Ability to route Seeds to an outsourced Ideation Challenge
via Crowd-source Aggegation System.
By outsourced Ideation Challenge instance hosted on a vendor's site.

IA Strategy Phase Tools
1. Ability to route Seed to an outsourced Strategy Challenge:
via crowd-sourced aggregation system
by externally outsourced Strategy Challenge instance at a vendor's site.
2. Automated Strategy recommendation tool: this system lists a table of patent strategies in a easy to use format and allows the Maven Team to select predefined strategies that would for example include:
   Architecture Model Strategies
      Client—Server protection
      Client-Server-Client protection
      Peer to Peer protection
      Client only protection
Litigation Model Strategies
   Enable litigation against user as infringer (esp. B2B models)
   Enable litigation against producer/provider of the system as infringer
   Enable litigation against supplier to the system as infringer
      1. Global Coverage Strategies
         1. List of countries to file in.
      2. Etc.
By selecting specific strategies for each Seed, Challenges are automatically generated based on the strategies selected.

IA Assembly Phase Tools
1. Ability to direct an IA Seed to an outsourced Assembly Challenge
   Via Crowd-source Aggregation Platform
   By an outsourced Assembly Challenge instance hosted at a vendors site.
2. IA Filing Tool: Ability to gather IA Seed results from the IA Assembly Phase Tools and load them into a IA Filing Tool. The IA Filing Tool would enable rapid editing, review and online or manual filing of the intangible asset in order to obtain a federal grant for intangible asset ownership. For example, if the Intangible Asset being processed were a patent, then this would be routed to the Patent Filing Tool. The Patent Filing tool would enable the rapid editing and review of the patent gathered from the assembly phase. If there were one or more components that were not satisfactory, of course the resulting IA Seed could be rerouted back into another IA Assembly Challenge to be remediated using the general maven team system functions and tools.

IA Defense Phase Tools
1. Ability to direct an IA Seed to an outsourced IA Defense Challenge
   Via Crowd-source Aggregation Platform
   By an outsourced Assembly Challenge instance hosted at a vendors site.
2. Patent Office Challenge Letter Loader: this would be an automatic system to scan and perform optical character recognition on the patent office challenge letter. Once it is loaded, it is automatically shredded into its component parts and loaded into the Seed Generation Editor. Once the IA Defense Seed is created, the seed is loaded into a IA Defense Challenge. One example of this would be a Patent Defense Challenge.
3. Automated Inventor Invitation Tool: this tool would enable to automatic invitation into the Defense Challenge of the participants of the inventors whose names are on the relevant claims being questioned by the patent office.

IA Fruition Phase Tools
1. Ability to direct to an outsourced Fulfillment Management vendor
   Via Crowd-source Aggregation Platform
   By an outsourced Fulfillment Management instance hosted at a vendors site.
   Client IA Grant Lay-away Area: The Lay-away area is a temporary storage area that enables a client to hold an IA Grant until the Lay-away term expires. If the lay-away term expires for a specific IA Grant then it is transferred to a general IA Grant Inventory.
   Automatic IA Grant and milestone notification tool—As IA Grants happen, they start the clock and for a predetermined amount of time periodically notify the client how much time is left to purchase the IA Grant. The period of the milestone notifications are adjustable by the client. Each notification includes a link to the client's invoice.
   Automatic client invoice system—The client invoicing system requires authentication. As IA Grants happen, they are automatically added to the client's online invoice. On the invoice, each line item has a link to the granted Intangible Asset (ie patent, copyright, trademark, etc) Grant for client review. The client has the option of laying-away specific invoice line items which will put the IA Grant in a temporary lay-away area. At any time, until the IA Grant Lay-away terms expire, the client can add a lay-away item back into their invoice and pay for it.
   Automatic one-click IA Invoice payment—When a client goes to their invoice, by default all IA Grants are on the invoice and selected to be purchased. The client can click one button to buy everything listed in the invoice. The one-click button activates the system to check the user's payment methods (PO, prepaid account, bank account, paypal, credit card, etc) and automatically uses the user's preferred method of payment. If the preferred method of payment is insufficient to fulfill payment, then the client is given the option to split payment over multiple payment instruments. Notification of this kind of event is sent to the operations team and the client's sales representative. If paying via multiple payment instruments fails, then notification is again sent to operations and the sales representative for the client and the transaction fails.
2. Crowd-sourced Intangible Asset Tree Management System—the CIATMS is a system and method for harnessing the capabilities of the crowd in order to create high quality Intangible Assets. The CIATMS comprises an Intangible Asset Tree container which is initialized with an Intangible Asset Seed. The IATree contains one or more Branches which are containers whose goal is to produce a single Intangible Asset at the end. Each IATree Branch contains a sequence of Crowd-sourced Phases. Each Phase contains one or more Sprints that are run sequentially one-after the other. Each Sprint contains one or more Crowd-sourced Challenges which are run simultaneously plus a stagger value.

### Example System Walkthrough

To bootstrap an IA Tree, the Maven Team System uses an Intangible Asset Seed to create one or more IATree Branches. Each branch is initialized with an Intangible Asset Seed and an initial challenge text as the focus for the entire branch. The initial challenge text is used to populate the first contribution of the Forum and the IA Seed is used to populate the Challenge's wild description of the challenge. At this point, members can create “ideas” by clicking on a “new idea” button and submitting a contribution which may consist of text, diagrams, or any other IA Seed component. The contribution is added to the forum. The idea is initialized with the minimally the following three components:

1. an empty IA Seed which will be populated by the crowd

2. a reference to the originating contribution

3. a reference to a wiki interface configured to present the IA Seed to the crowds.

The system then traverses the originating contribution and proceeds walking up the forum post hierarchy and gathering contribution components until the system reaches another contribution that is used by another idea. All of the member ids of the contributors of the ancestor forum posts are invited to become moderators for the Idea Wiki to which they have contributed. The contributions of the ancestors are all gathered and sorted into the empty IA Seed as the beginning of a new IA Seed. In another situation, members can continue refining ideas by posting additional contributions until it becomes an idea that someone in the community strongly believes in and decides to “promote” to an “idea”. At this point the same process is performed when a member pressed the “new idea” button. In this scenario, the community member who volunteers to “promote” an idea also becomes a moderator for the Idea Wiki.

Crowd-Sourced Challenge Management System

The Crowd-sourced Challenge Management System enables an expert team system (Maven Team System) to manage the crowd-source creation of Intangible Assets. The goal of the Maven team is to manage all aspects of the creation of Crowd-sourced Intangible Products including
1. Intangible Asset Loading Challenges
2. Intangible Asset Seed Creation Challenges
3. Intangible Asset Ideation Challenges
4. Intangible Asset Strategy Challenges
5. Intangible Asset Assembly Challenges
6. Intangible Asset Defense Challenges

The Maven Team must also be able to incentivize the crowd in order to keep them motivated to work. The Platform supports the following incentive systems to motivate the crowd for collaborating to create a desired Intangible Product.

a. Material Awards
I. Award Ceremonies
II. Monetary Awards
III. Token Awards (Patent Plaques, Badges, Team Trophies, etc)

b. Virtual Awards
I. Virtual Award Ceremonies
II. Virtual Status
   1. Points
   2. Inventor Profile
   3. Ladders
   4. Followers
III. Virtual Tokens (Patent Plaque image, Badge image, Team Trophy Image, etc) for each member's personal Virtual Trophy Case.

3. Patent Tree Management System

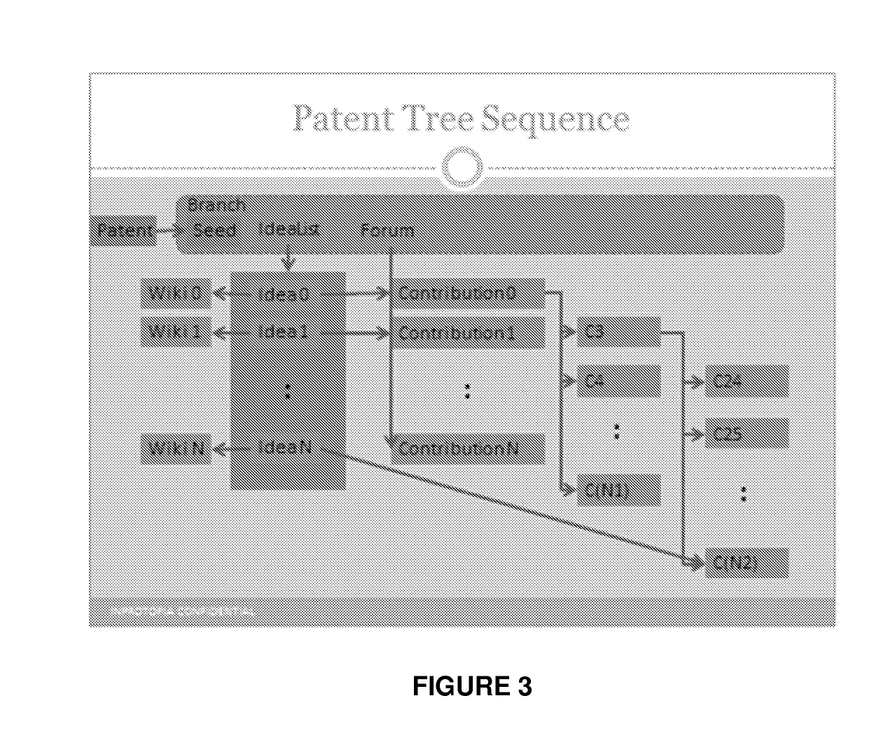

One example of an Intangible Asset Tree Management System would be a Patent Tree Management System as shown in FIG. 3. The data-structures used to manage the forums, wikis and challenges may be, for example, as shown in FIG. 3

Member to Member Messaging (M2M Messaging)

Members are able to communicate with each other in a variety of methods on the Platform as shown in FIG. 1B. This would include common methods including IM, email, posting to the person's public blog, or posting to the person's private blog. The M2M system will support public communications (multicast) as well as private communications (unicast). The M2M system will also support privacy in messaging so unwanted communications will not expose your contact information.

These kinds of 1-to-1 messaging systems are prevalent and we would integrate one or more of these 1-to-1 messaging systems into our platform. In order to support the requirement of not giving away the user's true contact information, we would have a protocol proxy that would enable the member to substitute their member name for their actual name. For example, if member A wanted to connect to member B via IM, then they would connect to a well-known IM proxy user for the company hosting the M2M service, then usernames would be replaced with the public profile names in both directions. This would then enable the users to IM each other using their own accounts without exposing their actual IM account IDs. This simple kind of pseudonymous proxying can be enabled for email, IM, IRC, and any other communication protocol.

Instant Patent Filing System (IPFS)

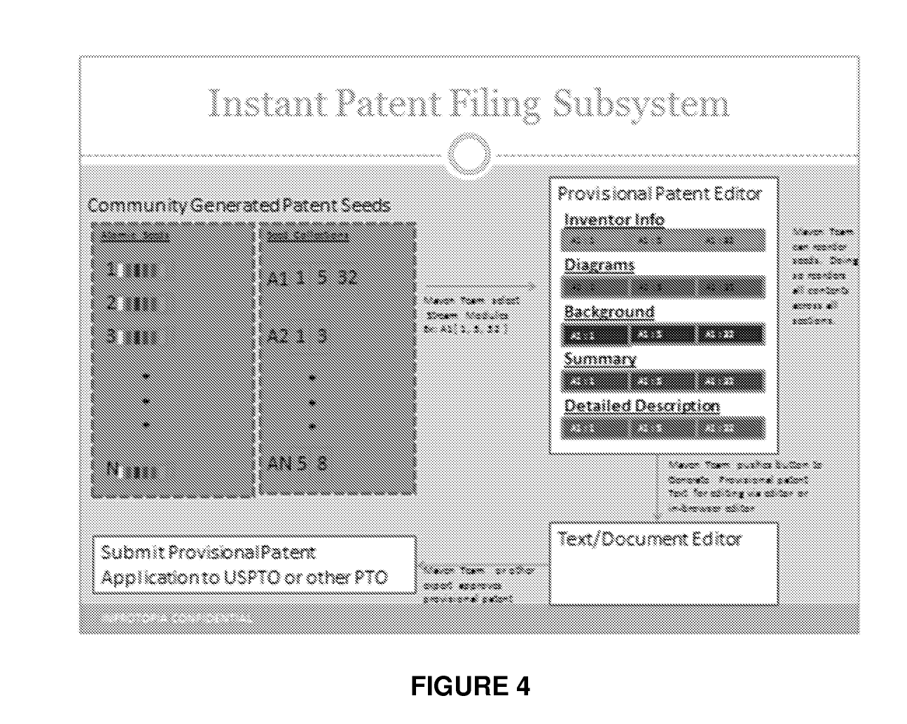

The IPFS (shown for example as 104g in FIG. 1A) is composed of a Patent Seed Editor; a system to transform Patent Seed format into Provisional patent format; and a connection to submit Provisional patents to USPTO. An example of the IPFS component is shown in FIG. 4. The Patent Seed Editor can load a Crowd-sourced Seed or Collection of Seeds. In the Patent Seed Editor, an expert can reorder the seed order which will change the order of the text of all seed components in the corresponding patent sections accordingly. When the user is satisfied with the order of the materials, the Patent Seed Editor can be used to generate the Provisional patent forms with a textual format of the invention along with diagrams. The resulting Provisional Patent document can be submitted either electronically or printed and sent via regular mail.

The IPFS is an example of an intangible asset generation system that generates one or more additional intangible assets from the original intangible asset, such as cluster patents from an original patent or a piece of prior art based on an original patent.

Automated Score Keeping System (ASKS)

ASKS is an automated score keeping system that is composed of a database of ladders.

The ASKS system comprises the following components:
1. Metric is a table that defines a metric type that is gathered in the Points table.
2. Points is a table that keeps track of all points earned throughout the system for a particular metric for a particular user.
3. Ladder is a table that links the Metric, Points and Users tables so a periodic Ladder can be generated.
4. LadderPageGenerator is a program that periodically runs over all Ladder types and generates an HTML page that summarizes the state of the ladder for a period of time. The page is stored into a structured page hierarchy that enables historical viewing of historical HTML pages of ladders for a given year, month, week, day and hour.
5. The Ladder Page hierarchy is periodically checked into a version control system for purposes of disaster recovery and replication.
6. A PointProbe is a piece of code that can be used to gather a specific type of point throughout the system and can be added to the system using Aspect Oriented Programming or directly implemented to gather data into the code of the system.

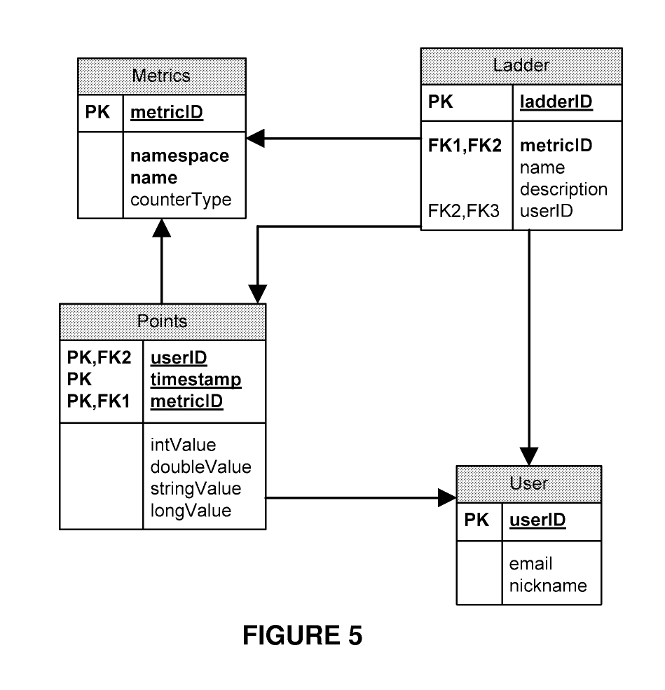

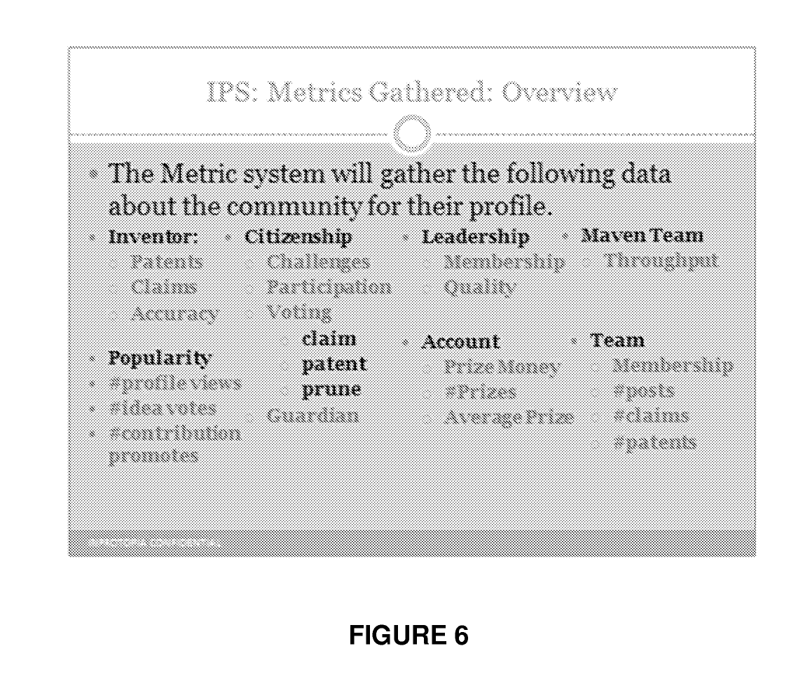

An example of a set of sample metrics that we would configure into the system are shown in FIGS. 5 and 6 and, more specifically, an exemplary list is shown in FIG. 6.

On the input side, ASKS can be configured to support specific types of metric types. Ladder types can be configured to be tracked for each of the metric types. Once the metrics and ladders are configured, ASKS dynamically tracks specific metric readings for a particular user from a PointProbe and stores it into the Points table. Periodic processes like the Ladder Page Generator can query the Ladder table to find all the elements in the Points table that are relevant for a time period and then can iterate over all memberIDs and calculate the scores for each member. As the Ladder Page Generator stores the HTML files into the filesystem, they are checked into a version control system from where clone LadderServers can obtain replicated ladder content.

Inventor Profile System (IPS)

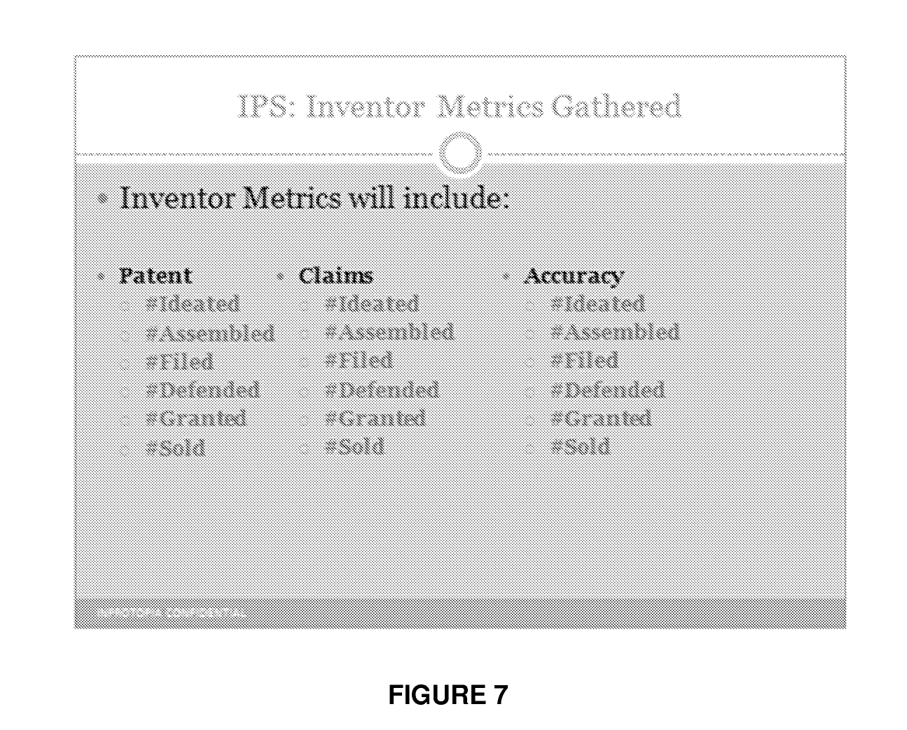

The Inventor Profile System is a system and method for enabling an inventor to see how they personally compare as an inventor using objective inventor metrics as a means for comparison. Given the ASKS database exists, the Inventor Profile System provides granular metrics on how well an Inventor performs as an individual. A user will have access to a view which includes only rows where the user is the signed in Inventor. All of this information is made available on the Inventor's statistics page, an example of which is shown in FIG. 7.

Crowd-Sourced IP Anti-Theft System (IP-ATS)

The IP Anti-Theft System is a system to address the possibility of a rogue community member trying to “misappropriate” IP from the crowd-sourced platform. There are a few ways that IP can be misappropriated from the platform. The first threat we address is the threat of a rogue member filing a patent based on the contents of an on-going Challenge. In order to mitigate this risk, before a Challenge is started, we file provisional patents for any idea that might be newly patentable. Furthermore, as a particular Challenge begins, we keep indelible logs of the discussion stream and creation of ideas. The logs will track every event within a challenge for example:
1. Who joined what challenge at what time
2. who made the posts at what time
3. who read which post at what time

These audit logs can be used in future litigation. These logs will provide time and dates down to the second as to when ideas were posted. With this logged in an indelible fashion (eg. Centerra, or printouts and US mail or some other means), then we would use multiple methods to monitor the patent application stream and the patent grant stream. There could be many ways that we could monitor and notify IP-ATS of a questionable application or grant. This could be done manually through crowd-sourcing or through the A-PENS system to automatically detect a patent application becoming visible or a patent being granted that would have been filed in the 2 week timeframe before we had filed our provisional. If we found a patent application or patent grant that looks questionable, then the IP-ATS would automatically check the following:
1. Is the inventor of the patent application that looks like it may have been stolen from our site a member of our community.
2. Is the inventor associated to a member of our community via a social-network. (facebook, linkedin, Google+, myspace, etc) Those skilled in the art know how to utilize the social graph APIs to navigate the relationships. Given the set of people who were active in the Challenge in question, we can search the social graph of the members to see if they are somehow associated with the inventor of the patent application that looks like it may have been stolen from our site.

Automated Patent Event Notification System (A-PENS)

See more details in Appendix A for this component.

Automated Patent Research Information Library System (APRILS)

The APRILS is a Crowd-sourced System that enables a maven team to fund a specific amount of research in order to generate a research library of references to materials that will help the crowd move forward. APRILS will allow the Maven Team to seed a Intangible Asset Tree Library with URLs to research. Based on funding, APRILS leverages and aggregates other crowd-sourcing platforms like Amazon Mechanical Turk, CrowdFlower, Clickworker, etc for the purpose of rapidly gathering research information and references for use within a particular patent tree. As another method of input, APRILS will accept reference additions by any community member. APRILS automatically makes the URLs to references available in the research library for a particular patent tree. On a Forum Contribution basis, APRILS can automatically match reference URLs that may be relevant to the specific Forum Contribution and then a community member can read the reference to either support or debunk the Contribution.

Inventory of Tools

Additional tools available to the community members include

Additional tools available to the community members include tools that facilitate the Crowd to do the tasks set forth for them to accomplish. For example, some of the tools may include a palette tool for each component of the Seed being used for the Contribution or Idea:
1. A research palette tool (implemented using javascript or other technology) which is populated either by an expert team, other community members, or a crowd-sourced subsystem like APRILS. These research links are made available to Community Members in context of a specific Idea or Contribution that they are examining. This could be activated by a roll-over or a button click or some other action. The relevant links could automatically be sorted to put the most relevant links toward the top. When someone analyzes the reference and verifies that it is relevant, then they can submit it as a contribution.
2. A drawing palette tool which is a library of unnamed stock drawings that can be rapidly browsed, labeled and submitted in response to another contribution. The drawing palette tool can be activated in context of a Contribution by a roll-over, button click, or some other action. The relevant drawings could automatically be sorted to put the most relevant drawings (eg. The drawings with the right number of boxes and relationships) toward the top of the list.
3. A Background text palette tool which is a library of Background paragraphs used to describe previous Seeds.
4. etc.

The components described above are also described in Appendix A that forms part of the specification and is incorporated herein by reference.

In addition to the use of the platform to generate ideas and intangible assets, such as patents, as described above, the platform also may be used for searching for prior art for one or more claims of a patent using a similar procedure and components as described above.

While the foregoing has been with reference to a particular embodiment of the invention, it will be appreciated by those skilled in the art that changes in this embodiment may be made without departing from the principles and spirit of the disclosure, the scope of which is defined by the appended claims.

1. A crowd sourced platform for intangible assets, comprising:
a computer system having a processor and a memory;
a store, associated with the computer system, that receives a plurality of atomic components of the intangible asset;
a seed creation system, hosted on the computer system, that generates one or more seeds from the plurality of atomic components of the intangible asset;
a challenge management system, hosted on the computer system, that manages a plurality of challenges, each of the challenges being participated in by a plurality of crowd members using the one or more created seeds; and
an intangible asset generation system, hosted on the computer system, that generates one or more additional tangible assets based on the challenge.

2. The platform of claim 1 further comprising a patent defense system, hosted on the computer system, that manages a defense of a filed intangible asset.

3. The platform of claim 1, wherein the intangible asset is one of a patent, a defensive publication, a piece of copyrightable material, a trademark, a service mark and a piece of prior art.

4. The platform of claim 1 further comprising an intangible asset filing system, hosted on the computer system, that files the generated intangible asset.

5. The platform of claim 4, wherein the intangible asset is a patent and the intangible asset filing system is a patent filing system.

6. The platform of claim 1, wherein the computer system is one of one or more server computer and one or more cloud computing resources.

7. The platform of claim 1 further comprising an intangible asset loading system that loads the intangible asset by the plurality of atomic components of the intangible asset.

8. The platform of claim 1, wherein each atomic component is one of a paragraph, a diagram, a reference and a molecule definition.

9. The platform of claim 7, wherein the intangible asset loading system is a patent loading system and wherein the plurality of atomic components are one of a paragraph, a diagram and a reference.

10. The platform of claim 1 further comprising a maven system, hosted on the computer system, that allows an expert to manage the plurality of crowd members.

11. The platform of claim 1, wherein the challenge management system manages one or more challenges that are available to each crowd member based on a set of crowd member characteristics.

12. A method, comprising:
receiving a plurality of atomic components of the intangible asset;
creating, using a seed creation system, one or more seeds from the plurality of atomic components of the intangible asset;
managing, using a challenge management system, a plurality of challenges, each of the challenges being participated in by a plurality of crowd members using the one or more created seeds; and
generating, using an intangible asset generation system, one or more additional tangible assets based on the challenge.

13. The method of claim 12 further comprising managing, using a patent defense system, a defense of a filed intangible asset.

14. The method of claim 12, wherein the intangible asset is one of a patent, a defensive publication, a piece of copyrightable material, a trademark, a service mark and a piece of prior art.

15. The method of claim 12 further comprising filing, using an intangible asset filing system, the generated intangible asset.

16. The method of claim 15, wherein the intangible asset is a patent and wherein filing the intangible asset further comprising filing the patent.

17. The method of claim 12 further comprising loading, using an intangible asset loading system, the intangible asset by the plurality of atomic components of the intangible asset.

18. The method of claim 12, wherein each atomic component is one of a paragraph, a diagram, a reference and a molecule definition.

19. The method of claim 17, wherein loading the intangible asset further comprises loading a patent and wherein the plurality of atomic components are one of a paragraph, a diagram and a reference.

20. The method of claim 12 further comprising managing, using a maven system, the plurality of crowd members by an expert.

21. The method of claim 12, wherein managing the challenges further comprises managing the one or more challenges that are available to each crowd member based on a set of crowd member characteristics.
